(19) United States
(12) Patent Application Publication
(10) Pub. No.: US 2018/0370250 A1
(43) Pub. Date: Dec. 27, 2018

(54) METHOD OF PRINTING ON A SURFACE OF A SPHERE AND AN APPARATUS FOR PRINTING ON A SURFACE OF A SPHERE

(71) Applicant: VMG ECO Sp. zo.o, Poznan (PL)

(72) Inventors: Piotr MUSZKIETA, Poznan (PL); Maciej PRZYWECKI, Kornik (PL); Krzysztof Jan WEGNER, Murowana Goslina (PL)

(21) Appl. No.: 16/052,941

(22) Filed: Aug. 2, 2018

Related U.S. Application Data
(63) Continuation-in-part of application No. PCT/PL2016/000131, filed on Nov. 25, 2016.

(30) Foreign Application Priority Data
Jun. 17, 2016 (PL) P.417620

(51) Int. Cl. B41J 3/407; B41M 5/00

(52) U.S. Cl. CPC B41J 3/4073; B41M 5/0088

(57) ABSTRACT

A method of printing on a surface of a sphere and an apparatus for printing on a surface of a sphere are disclosed, which are used to apply images recorded by omnidirectional 360 cameras, which allow the recording of images in all directions simultaneously. In particular, the print is applied by a printing head over a line which enables printing of each fragment of the sphere surface only once. The apparatus is in the form of a sphere holder and a printing head, wherein the ball is mounted on the base on a rotary support, which rotates the sphere, and the printing head is located on the zone of the sphere surface.

### CROSS-REFERENCE TO RELATED APPLICATIONS

The present application is a continuation-in-part of International Application No. PCT/PL2016/000131, filed on Nov. 25, 2016, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The subject of the invention is a method of printing on a surface of a sphere and an apparatus for printing on a surface of a sphere, used to apply images recorded by omnidirectional 360 cameras, which allow the recording of images in all directions simultaneously.

### 2. Description of Related Art Including Information Disclosed Under 37 CFR 1.97 and 37 CFR 1.98

The image recorded by such a camera represents/describes the light which reaches the camera from all direction at a given instance of time, when the image (light, photo) was taken. Such an image represents the stream of light which passes through a certain surface (usually a sphere) surrounding camera. Image capturing is typically done using one or multiple electronic light sensitive sensors which can record the amount (intensity) of light in three ranges corresponding to three primary colours (red, blue and green).

Due to the fact that an omnidirectional image represents a stream of light, the image is not recorded on a flat surface, like in typical photo cameras, but on a sphere. As a consequence an image registered in this manner cannot be printed using traditional printing devices, such as laser or inkjet printers, since they are adapted to printing on flat surfaces.

An image is a collection of pixels which represent the amount and colour (wavelength) of light which was fixed or recorded by a photo camera device. In case of digital photography image is a collection of pixels described in a colour space described by RGB (red, green, blue) components. This model results from the properties of human eye, where an impression of any colour may be caused by mixing three light beams in specific proportions. The RGB space uses additive colours, where the lowest values mean complete black, and the highest—white.

For printing, colours are described using a CMYK palette of four basic colours (cyan, magenta, yellow and black). The final colours in the CMYK method are obtained by combining each the primary colours in proportions from 0% to 100%. CMYK inks are dyes which transmit (or scatter) light, so they are combined not by mixing, but by application by layers, which is why the resulting colour may have from 0% to 400% of colour (that is component colours). Colours created using CMYK should be viewed as layers of coloured, light transparent film.

Conversion of an image generated by a digital device in an RGB space to a CMYK palette colour is performed by special software which edits and processes the recorded image and prepares the material for printing.

The invention concerns a method for the application of a print which represents an omnidirectional image on the surface of a spherical medium, which may be a ball made of plastic, laminate or another printable material.

It is known from Japanese patent JP H0768851 A “Spherical surface printing device”, where to stabilize printing quality and increase the positional accuracy of printing by a method wherein a guide frame and the like, which move a printing head into a direction orthogonal to the rotating direction of a holder along the surface of a matter to be printed, are provided.

The solution described is that when printing is started, a printing head moves up-and-down along a guide frame as shown by a printing head moving direction A whereby data for one row are printed. Thereafter, holders are rotated by a given angle as shown by a holder rotating direction B whereby printing for next row is prepared by facing the new printing surface of the matter to be printed toward the printing head. Printing on the matter to be printed is effected by repeating such an operation. On the other hand, the guide frame is moved toward a guide frame moving direction C whereby printing on a matter to be printed which is provided with a different size (radius of curvature). can be effected, Accordingly, the moving locus of the printing head can be changed depending on the size of the matter to be printed whereby printing on a conventional matter to be printed can be effected.

It is known from Japanese patent JP 2007008110 A “Inkjet printer for sphere madia print and printing method using the same”.

The solution described is that the inkjet printer has an X direction moving mechanism moving the spherical media supported by the supporting means in an X axial direction of a supporting means, a Y direction moving mechanism moving the spherical media in a Y axial direction of the supporting means, a Z direction moving mechanism moving the spherical media in a Z axial direction of the supporting means, an X axial rotating mechanism rotating the spherical media around the X axis of the supporting means, and a Y axial rotating mechanism rotating the spherical media around the Y axis of the supporting means. Further the inkjet printer has a returning means rotating and returning the spherical media around the X axis of the supporting means to the rotating starting position, and an image correcting means adding and introducing blanks between dots of ink formed by discharging the ink from an inkjet head 1 and shooting the same onto the spherical printing face directly under the inkjet head and lining in the Y direction for image printing to correct the distortion of the image printed on the spherical printing face.

Japanese patent JP 2006069104 A presents a new printer system which is designed to expand the range of application of a projector and combines the projector with a printer.

The printer system has a projector capable of projecting an image on a printing object medium W and a printer to print the same image as a projected image on the printing object medium W. The printer includes a printing mechanism to print a three-dimensional printing object medium. The printing mechanism includes a pair of frames, flexible arms attached between the frames and a printer head attached to the flexible arms and moved for scanning by using the frames as rails.

Japanese patent JP2001315316 A presents a recorder exhibiting excellent adhesion of coloring agent to a curved face recording medium and producing a good image.

The recorder comprises means for carrying a recording medium having a curved recording face, means for supplying an aqueous ink containing a coloring agent and resin emulsion particles to a curved recording face, means for supplying a reaction liquid containing a reaction agent producing aggregate upon touching the aqueous ink to the curved recording face, means for supplying a cleaning liquid to a mixture of the composition of aqueous ink and the reaction liquid before completion of filming reaction, a control means for touching the aqueous ink and the reaction liquid at a specified position, and a control means for supplying the cleaning liquid to the mixture of the aqueous ink and the reaction liquid before completion of filming reaction.

It is known from American patent U.S. Pat. No. 4,898,485 A “Method and apparatus for marking on an arcuate surface” which a marking device includes a plurality of individual marking pin assemblies. Each marking pin assembly is spaced an angular' distance from each adjacent marking pin assembly in the marking device to form a generally fan-shaped array. An arcuate object to be marked by the marking device is placed on an object support plate. As the arcuate object is rotated on the object support plate, the plurality of marking pin assemblies in the marking device operate to selectively imprint a plurality of pre-selected characters in the circumference of the arcuate object.

Chinese patent application CN 101279544 A presents a method and apparatus for jet printing on a ball surface by means of a print head mounted on an arched rail.

Also known is international publication WO 00/51821 A (international application PCT/US00/05265) “Methods and systems for printing on spherical objects”.

The printing system and method applies images to an object, such as a golf ball, through the use of one or more print heads. The object is mounted in a manipulator assembly that rotates the object as the image is transferred to the object. The print head is also movable with respect to the object so that it is at a desired distance from the object as it prints from one end of the object to the other. A plurality of print heads may be provided with each print head applying a different color to the object. These print heads may be arranged in a vertical fashion with the object traveling in a vertical direction between the print heads or the object may be mounted on a rotatable table with the print heads situated about the perimeter of the table. Images to be applied to the object are broken down into their constituent colors with the image data for each color being provided to a separate print head. The image data for each color is further broken down into individual tracks that are successively applied to the object. The system may be used to print images on a plurality of objects that are automatically routed through the system.

In the currently available solutions, in order to print an omnidirectional image, in addition to converting an image from the RGB space to CMYK it was necessary to represent the location of the recorded light intensity (image colour point) on the surface of a sphere to a corresponding location on a flat printout surface in accordance with the required mapping. For this purpose cartographical mappings are used, which allow the stretching, mapping or representation of a spherical geometry, such as: cylindrical representation, azimuth representation, stereographic representation, pseudoconic representation, Mollweide representation, Lambert representation and others.

Should any mapping of a sphere onto a plane is used, an omnidirectional image recorded on a sphere is distorted in various manners after printing.

Another method of printing an omnidirectional image is direct printing of an image on a ball. In the solutions known and used so far an image on a sphere-like surface is obtained by using:
water transfer printing
pad printing
combined method, using a computer printer, application for appropriate selection of the drawing areas on the pattern, and a cutting plotter.

A spherical image created during a 3D spatial printing using drop on powder (CJP, Colorjet Printing)—the only currently available on the market technology which enables the representation of a photo on a sphere, however has two significant limitations:
very low quality of the presented image,
restriction in the size of the printed element (sphere) to the limit size of the 3D printer (depending on the model the maximum diameter is approx. 30 cm).

When using currently available devices and technologies a spherical image may be fixed by the use of technology combining 3D powder printing with the colouring of the powder using during printing (a 3D spatial powder printing, that is CJP (Color Jet Printing)). However, this is a complicated, and multi-stage industrial manufacturing technology, which is currently not being developed due to the development of much more effective and easier to control 3D printing process—e.g. PolyJet technology (models are based using acrylic resin which is hardened with ultraviolet radiation in layers with a thickness of multiple μm).

In the CJP (ColorJet Printing) technology, the creation of a model consists of selective binding of powder using a special, colour binder placed using printing heads similar to the ones in inkjet printers. The process of application and binding of individual layers is repeated until the entire model is finished. A colour image (in this case a photo image on a sphere) is created by binding a properly coloured powder, layer after layer. An image thus created has a very low quality (low contrast, very soft colours and a coarse surface).

All the methods listed above have very important defects compared to the subject of the invention, which practically prevent the effective mapping of the photo on the sphere's surface.

Water transfer printing (hydrographic) is performed by transferring onto items of an image which was printed earlier using flexographic printing on a special, organic transfer film. The graphics are transferred by the immersing the decorated item in water, on the surface of which the film with the printout has been placed earlier. It is a relatively simple technique, which enables obtaining extremely spectacular effects, however it has multiple restrictions. Water transfer may be used on all types of materials (from wood to glass), but requires special preparation of the surface (cleaning, polishing and spraying of special undercoat).

Restrictions
due to the need of using a special flexographic printed transfer foil for the application, it is practically impossible to use an arbitrary created image. Very high costs of preparing polymer flexographic stencils in practice restrict the list of patterns which may be used in this decorative technology to proposals of designs prepared by specialised printing houses, which reuse specially designed stencils.
due to a problem with the orientation of the applied drawing compared to the decorated item and due to numerous distortions which result from stretching and overlapping of fragments of the water transferred drawing film, effective decoration of items with this method may be performed solely using wallpaper patterns (e.g. patterns of wood, fibre, camouflage, animal skin etc.).
items to which figures are transferred using the described technology have to be made of water-resistant material due to the need for immersion in water.
the image transferred to the item being overprinted should be fixed by spray-painting with a transparent lacquer, which additionally complicates the technological process.

Pad printing is an indirect printing method, which is a derivative of intaglio printing, consisting of application of printer's ink using a soft, smooth pad. An appropriately shaped pad enables printing on uneven and irregular surfaces. By selecting printer's ink it is possible to print on surfaces (profiles) such as plastic, rubber, glass, metal etc.

For printing with this technique the following are needed: pad printing machine, matrix (polished metal or polymer plate with engraved or etched pattern), pad and ink.

Restrictions
printing is not possible with tonal transitions and combining colours (necessary e.g. when printing photos) due to relatively large ruling and raster dot size.
difficult process of preparing matrices for print which requires special process equipment (imagesetter, matrix etching station).
technology which is completely unprofitable for printing single items.
may in practice be used only for large print runs.
impossible to transfer accurate (high resolution) graphics and tonal transition graphics (such as photos) onto the surface of a sphere.

A spherical image prepared with a combined method—using currently available devices and technologies, such as a computer printer, application for appropriate distribution of image areas on a pattern, and a paper cutting plotter enables one to present a spherical image by placing graphics on a polyhedron as close to a sphere as possible. By using a special application which enables the modification of a recorded spherical photo file, fragments of images are transposed in a manner which enables printing the image on paper and cutting the drawing by using a cutting shape defined in the software. At the end the cut element is assembled by using special locks (cuts to the paper which enable the connecting of individual edges), as a consequence creating a spatial polyhedron which approximates a sphere.

Creation of a printout with the aforementioned technique is very difficult and time-consuming, it also requires good manual dexterity, access to special software and to a paper cutting plotter. The shape finally obtained is not a sphere, but a polyhedron which approximates a sphere.

### BRIEF SUMMARY OF THE INVENTION

The essence of the invention, which is a method of printing over a surface of a sphere by moving a printing head along the surface of a sphere, consisting of application of the print by a printing head over a line enabling the printing of each fragment only once, characterised by the printing head printing great circles passing through both poles of the sphere.

It is advantageous when the printing head prints great circles which are at a maximum distance from the previously printed great circles.

It is particularly advantageous, when the printing head prints the first great circle, then the great circle spaced 90 degrees from the first great circle, then subsequently the two great circles at a 45 and 135 degrees angle to the first great circle, then subsequently four great circles at a 22.5, 67.5, 112.5 and 157.5 degree angles to the first great circle, then the remaining surface of the sphere.

It is also advantageous when the print is applied by the printing head to a surface of the sphere over a helix line from the first pole of the sphere to the second pole of the sphere.

It is advantageous when the first pole of the sphere is the bottom pole of the sphere and the second pole of the sphere is the top pole of the sphere.

In the solution according to the invention an omnidirectional image could have been already transformed using one of the aforementioned sphere mappings. In this case it is advantageous when the printing head prints the image around the sphere, whereas the omnidirectional image in a cylindrical projection is divided into strips, with a width that depends on the distance between the strip and the equator of the sphere. The farther from the equator towards the sphere poles, the narrower are the applied strips. The image of the strips (layout of colours in the image) then controls a printing head which applies the image to the surface of the sphere being printed, using droplets of ink or toner, in accordance with the layout of colours in the image strips.

According to the invention the print is applied on the sphere surface using a printing unit in the form of a sphere holder and a print head, where the sphere is placed on a base on a rotating support in the form of a mandrel, rotating around its lengthwise axis, and the printing head is located in the zone of the sphere surface. The essence of the printing unit consists of an element with two arms is placed on the base, with a swinging half-ring installed at the end of the arms on swivels, whereas the swivel rotation axes are located in the ball's equatorial plane, whereas on the half-ring a slider with a moving arm is installed, at the end of which a printing head is installed.

It is advantageous when the image is applied on the surface of the sphere by a raster placement of pixels or by a random placement of the pixels.

It is moreover advantageous when the head for the printing of images on the surface of the sphere are writing implements, advantageously a pen.

The use of the solution presented in the invention enables the following technical and utility effects:
overprinting of the sphere surface without needing to use any mapping which distorts the omnidirectional image,
precise placement of the print on the sphere surface,
uniform printing of the entire sphere surface,
high quality of the printed image obtained by the high contrast and sharpness of the print, which result from the contours of fragments of the printed image do not overlap,
short time needed to print the image on the sphere surface,
synchronisation of the reciprocal movement of the printing head and the printed sphere,
printing over a sphere with any radius,
continuity of sphere surface printing by synchronisation of the sphere rotation and the operation of the printing head.

### BRIEF DESCRIPTION OF THE DRAWINGS

The subject of the invention, in an example implementation, which is not limiting, was presented in diagrams on a figure, on which, to better present the invention, the apparatus for the printing of the sphere surface was presented first.

FIG. 1 illustrates the unit in a the first version of the implementation.

FIG. 2 illustrates the unit in the second version of the implementation.

FIGS. 3a-3e illustrate subsequent phases of printing the image in accordance with the present invention.

FIG. 4 illustrates the method of printing an image in cylindrical projection on the sphere surface.

FIG. 5 illustrates the unit in the second version of the implementation with a second set of pressure rollers.

### DETAILED DESCRIPTION OF THE INVENTION

In the apparatus for overprinting of the surface of the sphere 1, in the form of a sphere 1 holder 2 and a printing head 3, the sphere 1 is mounted on the base 4 on a rotary support 5, which rotates the sphere 1, and the printing head 3 is located on the zone of the sphere 1 surface.

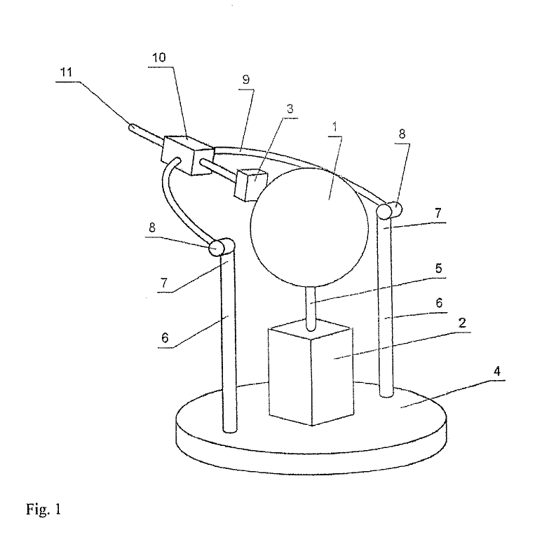

There are versions of implementation shown on FIG. 1 where the rotary support 5 is a mandrel which rotates around its lengthwise axis, and an element with two arms 6 is placed on the base 4, with a swinging half-ring 9 installed at the end of the arms 7 on swivels 8, whereas the swivel 8 rotation axes are located in the sphere's 1 equatorial plane, whereas on the half-ring 9 a slider 10 with a moving arm 11 is installed, at the end of which a printing head 3 is installed.

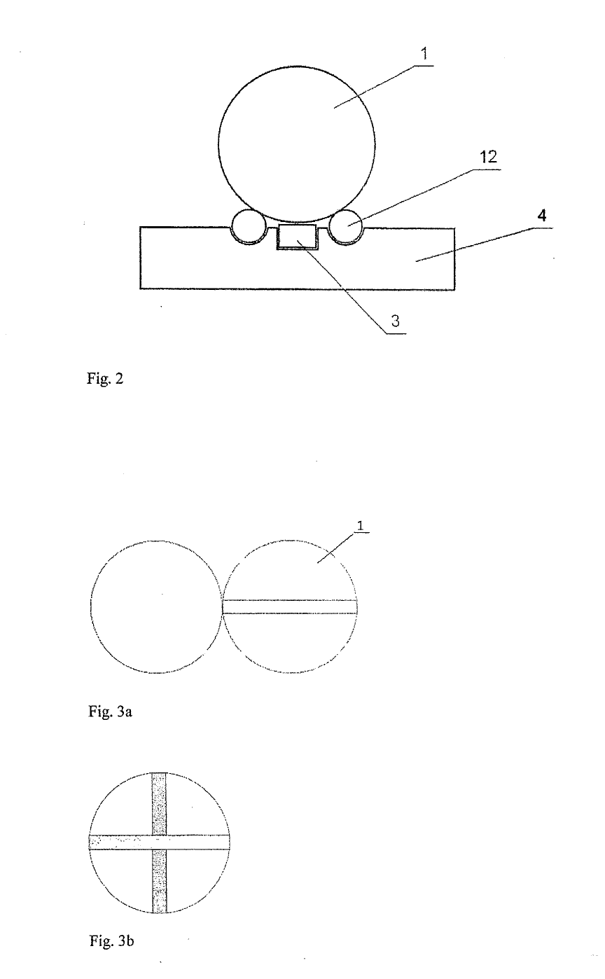

In the second version of implementation, shown on FIG. 2 the rotary support 5 is a system of powered rollers 12 installed in the base 4, which rotates the sphere 1, whereas the printing head 3 is placed in the base 4.

In the second version of implementation, shown on FIG. 5 the rotary support 5 is placed on the base 4 and in the case of the roller 12 pressure system 13 a system of powered rollers 12 to rotate the sphere 1, whereas the printing head 3 is installed in the base 4.

There are versions of the implementation when the image is applied on the surface of the sphere 1 by a raster placement of pixels or by a random placement of the pixels.

There are moreover versions of the implementation where the head for the printing of images on the surface of the sphere 1 are writing implements, advantageously a pen.

In the first version according to FIG. 1 the sphere 1 is intended for printing, placed on the base 4 on a rotary support 5. During the rotation of the printed sphere 1 the head printing head 3 moves from the pole of the printed sphere 1 towards the equator, applying a helical print on the surface of the sphere 1. The rotation of the sphere 1 with the movement of the moving part of the half-ring 9 is selected in a manner which ensures that every fragment of the sphere 1 was printed over exactly once. The unit enables the printing of the sphere 1 with varying diameters, due to the placement of the printing head 3 on a moving arm 11. The sphere 1 is mounted on a support 5, which enables its placement ensuring that its centre is located in the axis of rotation of the half-ring 9.

In another version of the implementation, according to FIG. 2, the printing head 3 is placed in an immovable manner on the base 4. Directly in the zone of the head 3, on the system of rollers 12 the sphere 1 intended for printing is placed. The system of rollers 12 enables the rotation of the sphere 1 in a manner which allows the printing head 3 to overprint every fragment of the sphere 1. The printed sphere 1 is held in the apparatus by its own weight.

In another version of implementation, shown on FIG. 5 the sphere 1 is pressed by a second set 13 of rollers 12.

A special process of printing control is implemented by an electrical control device, which enables the rotation of the sphere 1 during the printing in a manner that ensures that every fragment of the sphere 1 is printed over only once.

An integral part of the solution according to the invention is a method for controlling the printing device. In accordance with the method according to the invention an omnidirectional image is transformed to a continuous strip of image data in the form of a helix line, for the solution presented in the first version of implementation, or to a series of rings subsequently printed over the surface of a specially rotated sphere 1.

For both versions of implementation a continuous strip of image data represents subsequent image pixels placed over the sphere 1 surface (in the form of dots of ink, toner etc.), which narrows at the beginning and at the end is printed as a helical line from the one pole, to the other pole of sphere 1, whereas the narrowing of the image data strip at the beginning and at the end means that less pixels are placed in this area (less dots of ink, toner etc.).

Omnidirectional images are frequently recorded/stored in an equidistant cylindrical projection.

In case of a print of an image recorded/stored in a equidistant cylindrical projection the image is divided into strips of varying width (thickness). The width of a given strip (number of image pixels) depends on the distance of the given strip from the sphere 1 equator. The farther from the equator, the lower width of the strip. Finally the strips taken from the image are scaled to a continuous strip, which widens at the beginning and narrows at the end.

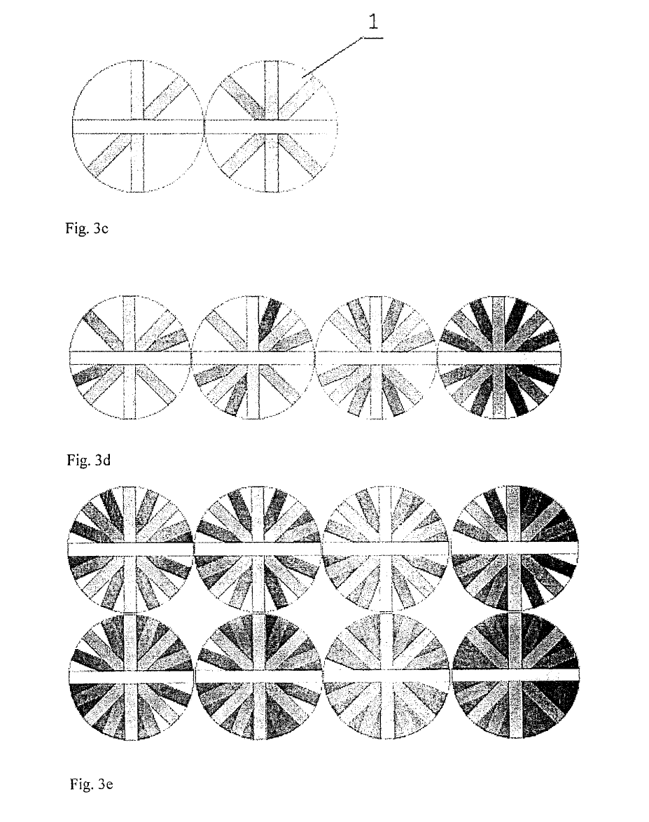

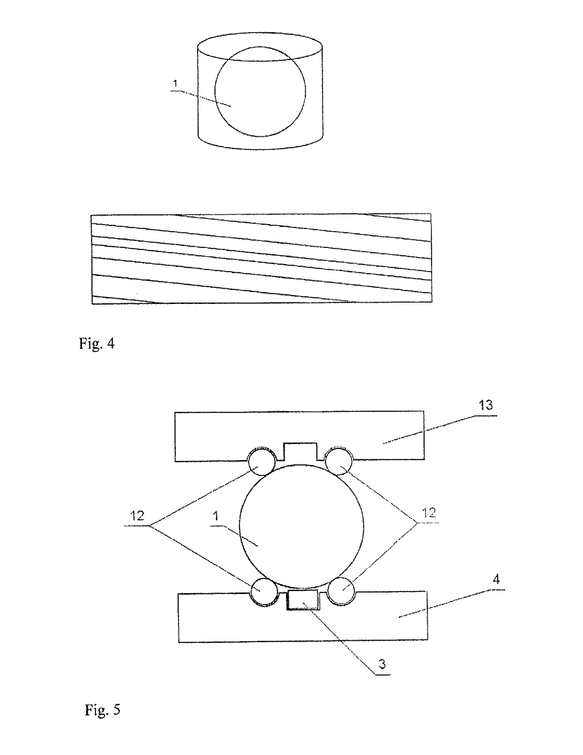

In the second version the surface of the sphere 1 is transected by a plane along the line which connects the poles of the sphere 1. This operation results in prints on the sphere's 1 great circle. By changing the longitude of the transecting plane multiple subsequently printers great circles of the sphere 1 are obtained, as shown on FIG. 3.

The great circle with the latitude of 0° is printed first—FIG. 3a. The great circle with the latitude of 90° is printed second, with the exception of two fragments printed earlier when printing the great circle with the latitude of 0°—intersections of the 0° and 90° circles—FIG. 3b. Two great circles at 45° and 135° angles to the first great circle are printed afterwards, then great circles at 22.5°, 67.5°, 112.5° and 157.5° angles to the first great circle are printed, FIG. 3c, FIG. 3d, then the remaining area of the sphere 1—FIG. 3e.

We claim:

1. A method of printing on a surface of a sphere by moving a printing head along the surface of a sphere, comprising of the print being applied by a printing head over a line which enables printing of each fragment of the sphere surface only once, characterized in that the printing head prints great circles passing through both poles of the sphere.

2. The method according to claim 1, wherein the printing head prints the subsequent great circles, which are at a maximum distance from the previously printed great circles.

3. The method according to claim 1, wherein the printing head prints the first great circle, and then the great circle at an angle of 90 degrees to the first great circle, then subsequently the two great circles at a 45 and 135 degrees angle to the first great circle, then subsequently four great circles at a 22.5, 67.5, 112.5 and 157.5 degree angles to the first great circle, then the remaining surface of the sphere.

4. The method according to claim 1, wherein the printing head prints around the sphere a multi-directional image in a rectangular reference system divided into strips of a width which depends on the distance between the strip and the equator of the sphere, whereas the farther from the equator to the poles of the sphere, the narrower the printed strips.

5. The method according to claim 1, wherein the print is applied by a printing head over the sphere surface on a helix line from the first pole of the sphere to the second pole of the sphere.

6. The method according to claim 2, wherein the first pole of the sphere is the south pole, and the second pole of the sphere is the north pole.

7. An apparatus for printing on the surface of the sphere, in the form of a sphere holder and a printing head, where the sphere is mounted on the base on a rotary support, in the form of a mandrel rotating along its lengthwise axis, and the printing head is located on the zone of the sphere surface, characterized in that an element with two arms is placed on the base, with a swinging half-ring installed at the end of the arms on swivels, whereas the swivel rotation axes are located in the sphere's equatorial plane, whereas on the half-ring a slider with a moving arm is installed, at the end of which a printing head is installed.

8. The apparatus according to claim 7, wherein the image is applied on the surface of the sphere by a raster placement of pixels.

9. The apparatus according to claim 7, wherein the image is applied on the surface of the sphere by a random placement of pixels.

10. The apparatus according to claim 7, wherein the head for the printing of images on the surface of the sphere are writing implements, advantageously a pen.
